(19) United States
(12) Patent Application Publication
(10) Pub. No.: US 2002/0071279 A1
(43) Pub. Date: Jun. 13, 2002

(54) Color illumination device

(76) Inventors: Masayuki Katogi, Tokyo (JP); Naohisa Iso, Tokyo (JP)

Correspondence Address: MARSHALL & MELHORN, LLC, Phillip S. Oberlin, 8th Floor, Four SeaGate, Toledo, OH, 43604, US

(21) Appl. No.: 09/989,997

(22) Filed: Nov. 21, 2001

(30) Foreign Application Priority Data
Nov. 24, 2000 (JP) 2000-358157

(51) Int. Cl. F21V 1/00

(52) U.S. Cl. 362/317

(57) ABSTRACT

A color illumination device of the invention comprises a plurality of color light sources for emitting lights of at least two different colors; a control unit for controlling the plurality of color light sources; a light mixture means for mixing the lights emitted from the color light sources to produce an illumination light, and a control operable to change a value of a variable, wherein the value of the variable determines a color of the illumination light.

### TECHNICAL FIELD

The present invention relates to a color illumination device capable of conducting variable-color illumination, and particularly relates to a color illumination device that can produce light of various colors with simple and easy operation.

### BACKGROUND OF THE INVENTION

It has been known for a long time to produce light of various colors by additive mixture of lights of the three primary colors, i.e., red, green and blue, and such a technique has been used in the field of stage lighting, for example. Recently, there is an increasing desire to use such color illumination in households and the like, and in order to fulfill such requirements, the assignee of the present application has proposed, in the international application PCT/JP99/01957 (International Publication WO99/53236) for example, a color illumination device that uses a series-connected plurality of low-volt capless small lamps as a light source so that the device can be directly connected to a commercial power source without using a step-down transformer. This color illumination device comprises a base plate, a plurality of low-volt (e.g., 25 V) capless small lamps mounted on the base plate via sockets, color filters of red, green and blue attached to the capless small lamps to form colored light emitting elements, and a light diffusing cover (or globe) for additive mixture of the red, green and blue lights emitted from the colored light emitting elements to obtain an illumination light of a color according to a proportion of the red, green and blue lights. The device is provided with three control elements each consisting of a variable resistance, for example, to individually control the intensity of the red, green and blue lights to vary the color of the light by the additive mixture. However, the individual operation of the control elements is quite inconvenient for a user, which practically keeps the user from using the multicolor function of the device.

In order to resolve the inconvenience in selecting a desired light color, Japanese Patent Application Laid-Open (kokai) No 10-125479 has proposed an illumination control system comprising a display means representing the light colors that can be emitted from the system in a two-dimensional color space so that, upon the user touching a desired color on the display means, the system detects the touched position and illuminates light of the color corresponding to the detected position. However, such a display means is quite expensive and requires a relatively large space, and thus may not be suitable for the use in general households.

U.S. Pat. No. 6,016,038 issued to Mueller et al. has disclosed a color lighting apparatus using a plurality of color light emitting diodes (color LEDs). This color lighting apparatus comprises a microprocessor or microcontroller which, according to a predetermined program, controls ON/OFF of switching elements connected in series to the LEDs of red, green and blue to thereby control the duty cycle of the electric current flowing through the LEDs of each color and thus control the intensity of the light emitted from the LEDs of each color. The color lighting apparatus may be used as a stand-alone system or may be connected to a network. However, there is no disclosure or indication for resolving the inconvenience in the operation to select the desired color of the emitted illumination light.

### BRIEF SUMMARY OF THE INVENTION

In view of such problems of the prior art, a primary object of the present invention is to provide a color illumination device that allows a user to select the color of the light produced from the device with a simple and easy operation.

A second object of the present invention is to provide such a color illumination device without substantially increasing the number of component parts or manufacturing cost.

A third object of the present invention is to provide a color illumination device that can provide various functions with simple operations.

A fourth object of the present invention is to provide a color illumination device that has a plurality of functional modes while allowing a user to easily and readily control an illumination effect in each functional mode.

A fifth object of the present invention is to provide a color illumination device that has a plurality of functional modes and allows a user to select a desired functional mode with a simple operation.

According to the present invention, such objects can be accomplished by providing a color illumination device for producing light of various colors, comprising: a plurality of color light sources for emitting lights of at least two different colors; a control unit for controlling the plurality of color light sources; a light mixing means for mixing the lights emitted from the plurality of color light sources to produce an illumination light; and a control operable to change a value of a variable, wherein the color illumination device has a first functional mode in which the value of the variable determines a color of the illumination light. Thus, instead of operating a plurality of controls independently provided to each of the light sources of different colors as in the prior art, it is only required to operate the single control to vary the color of the illumination light produced from the color illumination device, allowing easy selection of a desired light color and thus considerably improving the operability of the device.

Such a color illumination device preferably has a second functional mode in which the color of the illumination light is changed periodically in a predetermined pattern and the value of the variable determines a cycle of the periodic light color change, and also comprises a switch operable to select one of the functional modes of the color illumination device. The provision of the two different functional modes can allow a wider range of color illumination to be effected. Further, since the single control can function differently depending on the selected functional mode (i.e., in the first functional mode, the control determines the color of the illumination light while in the second functional mode, the control determines the cycle of the automatic change of the light color), it is possible to adjust an illumination effect in each functional mode to an operational condition or the user's preference without complicating the user interface structure of the device.

Preferably, when the functional mode is changed from the second functional mode (automatic color changing mode) to the first functional mode (manual color selection mode) by an operation of the switch, the illumination light color effected in the second functional mode at the time of the switch operation for the functional mode change is maintained in the first functional mode until the control is operated anew after the functional mode change. In this way, the user is allowed to stop the color change at a desired light color and thus change the functional mode smoothly without feeling any queerness. To achieve such smooth functional mode change, the control unit may comprise a memory for storing the color of the illumination light being produced; and a detector for detecting an operation of the control. In a preferred embodiment of the invention, such a memory and detector can be embodied by a CPU operating under an appropriate program.

Further preferably, the color illumination device may also have a third functional mode which is different from the first and second functional modes, wherein the switch comprises two different states associated with the first and second functional modes, respectively, and wherein in a case that the state of the switch is changed when the color illumination device is in the first functional mode and returned to the state before the change within a predetermined time period, the color illumination device enters the third functional mode. In this way, it is possible to select a desired functional mode among three different functional modes by using a switch having two states (for example, “open” and “close”), thereby achieving a color illumination device having various functions without increasing the number of operation elements. In the third functional mode, the color illumination device may repeatedly turns on and off at a predetermined fixed cycle, in which the value of the variable may determine a duration time of the turning on of the color illumination device.

In a preferred embodiment of the present invention, the plurality of color light sources comprise a red LED set having a series-connected plurality of red LEDs, a green LED set having a series-connected plurality of green LEDs, and a blue LED set having a series-connected plurality of blue LEDs, wherein the control unit comprises a first, second and third switching elements each connected in series to an associated one of the red, green and blue LED sets, and a CPU for controlling the first, second and third switching elements. Thus, by using a plurality of LEDs in the light sources and controlling them by the switching elements, it is possible to achieve a favorable color illumination device with a reduced heat dissipation.

It will be also desirable if the light mixing means comprises a first light diffusing member and a second light diffusing member interposed between the first light diffusing member and the plurality of color light sources, with the second light diffusing member having a light transmissive property. The second light diffusing member diffuses and mixes the lights of different colors from the light sources before the lights reach the first light diffusing member to thereby improve the mixture of the lights at the first light diffusing member. Thus, in the case where the first light diffusing member consists of a light transmissive cover, for example, it is possible to obtain a more uniform colored light across the entire surface of the cover. Such use of double light diffusing members is particularly effective when the color light sources comprise LEDs that tend to emit light in a relatively limited range of orientation and/or there is only a small distance between the light sources and the light diffusing member.

According to another aspect of the present invention, there is provided a color illumination device for producing light of various colors, comprising: a plurality of color light sources for emitting lights of at least two different colors; a control unit for controlling the plurality of color light sources; a light mixing means for mixing the lights emitted from the plurality of color light sources to produce an illumination light; and a control operable by a user, wherein the color illumination device has at least two functional modes and a function of the control is defined for each functional mode, and wherein the color illumination device further comprises a switch operable to select one of the at least two functional modes. Preferably the control is adapted to change a value of a variable, and the value of the variable is converted into an operation parameter defined for each of the functional modes. In a preferred embodiment, such a color illumination device may comprise a CPU operating under a predetermined program for storing the selected functional mode and for converting the value of the variable set by the users operation of the control into the operation parameter defined for the selected functional mode. In this way, it is possible to adjust the illumination effect (operation parameter) in each functional mode without increasing user-interface elements, whereby a color illumination device that has various functions and yet is easy to operate and thus particularly suitable for use in the households can be provided.

In one embodiment of the present invention, the switch is adapted to provide the control unit with a signal for indicating that the switch is operated, and in response to the signal from the switch, the control unit causes a current functional mode to switch to a next functional mode in a predetermined order of the functional modes. In this way it is possible to provide any number of functional modes and easily select a desired one of the functional modes by operating the single switch.

Other and further objects, features and advantages of the invention will appear more fully from the following description.

### BRIEF DESCRIPTION OF THE DRAWINGS

Now the present invention is described in the following with reference to the appended drawings, in which:

FIG. 1 is a front view of a color illumination device according to the present invention;

FIG. 2 is a circuit diagram of the color illumination device shown in FIG. 1;

FIG. 3 is a graph showing voltage and current waveforms at essential points in the circuit shown in FIG. 2;

FIG. 4 is a schematic diagram for explaining a preferred embodiment of functional mode change in a color illumination device according to the present invention;

FIG. 5 shows a preferred example of R, G, B light intensity changing pattern in an automatic color changing mode;

FIGS. 6-8 are each a part of a flowchart showing a control flow of a color illumination device according to the present invention; and

FIG. 9 is a schematic diagram for explaining another preferred embodiment of functional mode change in a color illumination device according to the present invention.

### DETAILED DESCRIPTION OF THE PREFERRED EMBODIMENTS

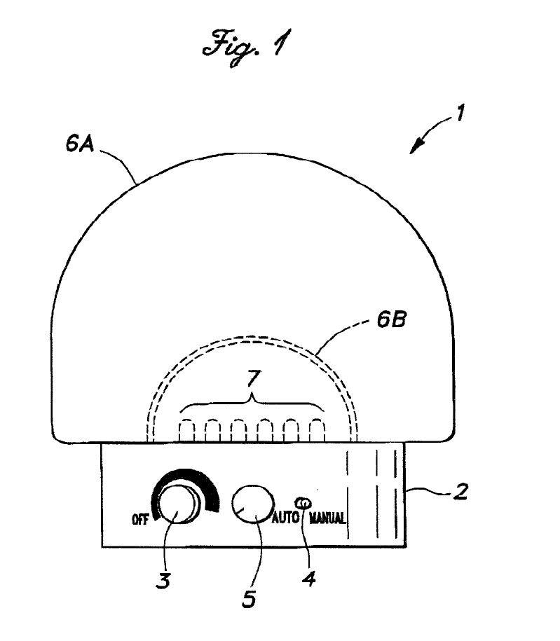

FIG. 1 is a front elevational view of a preferred embodiment of a color illumination device according to the present invention. This color illumination device 1 comprises a base 2, a plurality of colored light emitting elements 7 which are mounted on the base 2 and serve as color light sources for generating red, green and blue lights, and a cover (globe) 6A having a light transmissive and diffusing property and attached to the base 2 so as to surround the colored light emitting elements 7 whereby the red, green and blue lights generated therefrom are mixed on the surface of the cover 6A to produce a monochromatic illumination light of the mixed color. Each of the colored light emitting elements 7 may comprise a light emitting diode (LED) or an incandescent lamp fitted with a color filter, for example, among which the LEDs are preferred in view of the illumination efficiency, power consumption, etc. Electro-luminescent devices or discharge lamps also may be used as the color light sources. As described in detail later, the colored light emitting elements 7 are controlled by a control unit comprising a CPU (or microprocessor) so that an illumination Light of various colors can be obtained by varying the proportion of the red, green and blue lights emitted therefrom,

As shown by broken lines in FIG. 1, the color illumination device 1 further comprises another light-transmissive and diffusing cover 6B inside the cover 6A. The second, inner cover 6B serves to improve the diffusion and mixture of the lights generated from the colored light emitting elements 7 whereby a more uniform colored light can be obtained across the entire surface of the outer cover 6A. Such use of double light diffusing members may be particularly effective when the colored light emitting elements 7 comprise LEDs that tend to emit light in a relatively limited range of orientation.

The base 2 is provided with a switch 4 having two positions (AUTO and MANUAL) for selecting functional modes of the color illumination device 1, a first control 3, and a second control 5. The first control 3 is provided to control the brightness of the illumination light produced by the color illumination device 1, and in the shown embodiment, comprises a variable resistor operable via a rotatable knob so that by rotating the first control 3 clockwise, the brightness is increased. Preferably, the first control 3 comprises a power on/off switch in such a manner that fully rotating the first control 3 counterclockwise shuts off the power. The second control 5 is provided to control a predetermined operational parameter according to a selected functional mode, as described in detail later, and in the shown embodiment comprises a variable resistor operable via a rotatable knob.

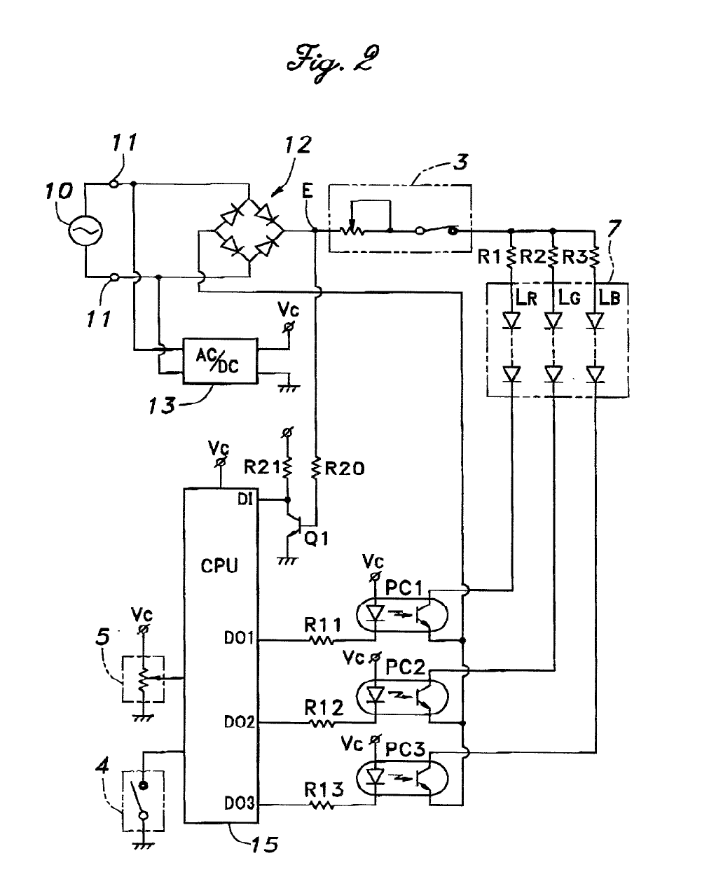

FIG. 2 shows a preferred circuit of the color illumination device 1 shown in FIG. 1. As shown, the color illumination device 1 comprises a pair of power supply terminals 11, 11 for connection to the commercial AC power supply of 100 V, for instance, and a full-wave rectifying diode bridge 12 and an AC/DC converter are connected to the pair of power supply terminals 11. 11. The AC/DC converter 13 serves to generate a substantially constant, low DC voltage (e.g., 5 V) to be supplied to various components of the circuit as an operation voltage.

The above described first control 3 is connected between a positive output terminal of the diode bridge 12 and the light emitting elements 7, which comprise a plurality of red, green and blue LEDs. More specifically, the light emitting elements 7 comprise a red LED set L_{R} comprising a series-connected plurality of red LEDs, a green LED set L_{G} comprising a series-connected plurality of green LEDs, and a blue LED set L_{B} comprising a series-connected plurality of blue LEDs. Each LED set may comprise more than one series connections of LEDs, with the series connections being connected in parallel. Thus, in the shown embodiment the red LED set L_{R} constitutes a red light source for emitting a red light, the green LED set L_{G} constitutes a green light source for emitting a green light and the blue LED set L_{B} constitutes a blue light source for emitting a blue light. It should be noted that the LEDs used may comprise a single-chip LED and/or a multi-chip LED comprising a plurality of LED chips unitarily packaged together. Also the LEDs may be of a lamp type or a surface mount type.

The red, green and blue LED sets L_{R}, L_{G}, L_{B} are connected to the positive output terminal of the diode bridge 12 via resistors R1, R2, R3, respectively, for regulating the maximum current flowing through the LED sets. Further, the three primary color LED sets L_{R}, L_{G}, L_{B} are connected to a negative output side of the diode bridge 12 via associated photo-couplers (Or opto-isolators) PC1, PC2, PC3, respectively. In other words, in this embodiment, the positive output side of the diode bridge 12 serves as a common line for the LED sets L_{R}, L_{G}, L_{B}. In this way, the LED sets L_{R}, L_{G}, L_{B} are connected in parallel with each other between the positive and negative output terminals of the diode bridge 12.

Each of the photo-couplers PC1, PC2, PC3 comprises an LED and a photo-transistor so that when an electric current flows through the LED to emit a light, the photo-transistor turns on in response to the emitted light. Such a photo-coupler may be available from Toshiba Kabushiki Kaisha of Tokyo, Japan, with a part number TLP628, for example. It is also possible to use a photo-coupler comprising a photo-diode or a photo-thyristor instead of a photo-transistor.

The color illumination device 1 further comprises a CPU (or microprocessor) 15, which may be embodied by the one available from NEC corporation of Tokyo, Japan by the part number μPD78F9116AMC-5A4, for example. As shown in FIG. 2, the photo-couplers PC1, PC2, PC3 are connected to connection pins D01, D02, D03 of the CPU 15 via resistors R11, R12, R13, respectively, so that output signals provided at these pins from the CPU 15 control the electric current flowing through the LEDs in the photo-couplers PC1, PC2, PC3.

The positive output terminal of the diode bridge 12 is also connected to a base of an NPN transistor Q1 via a resistor R20. An emitter of the transistor Q1 is grounded while a collector thereof connected to a connection pin D1 of the CPU 15 as well as to the DC voltage Vc via a resistor R27. As described in detail later, the transistor Q1 functions to provide the CPU 15 with pulse signals each indicating a boundary between adjacent positive half-waves of the output voltage from the diode bridge 12.

As also shown in FIG. 2, the switch 4 and the second control 5 mentioned above are connected to the CPU 15 so as to provide the CPU 15 with two different states (ON and OFF) corresponding to the two positions of the switch 4 as well as a voltage which varies with a position of the second control 5 whereby various functions as shown below can be achieved depending on the input signals provided to the CPU 15. It should be noted that for the clarity's sake, some of the connection pins of the CPU 15 are omitted in FIG. 2.

Now operations of the above-constructed color illumination device 1 are described hereinafter.

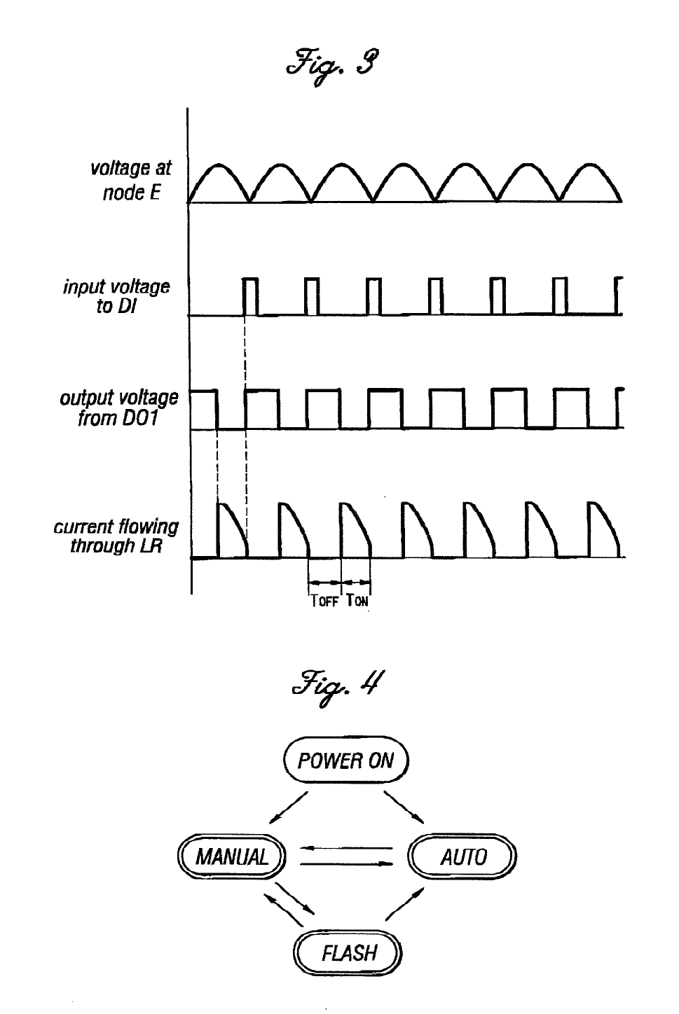

First, taking the red LED sets L_{R} as an example and referring to FIG. 3, it is explained how the intensities of the lights emitted from the three primary color LED sets are controlled. FIG. 3 is a waveform diagram showing the output voltage of the diode bridge 12 (or the voltage at a node E in FIG. 2), the voltage input to the connection pin DI of the CPU 15, the output voltage from the connection pin D01, and the electric current that flows through the red LED set L_{R}. As shown in the uppermost waveform in FIG. 3 the output voltage from the diode bridge 12 comprises a plurality of positive voltage half-waves.

The transistor Q1 shown in FIG. 2 is adapted to turn on when the output voltage from the diode bridge 12 is greater than a predetermined threshold value and to be in an OFF state otherwise. Thus, as shown in the second uppermost waveform in FIG. 3, the connection pin DI of the CPU 15 is provided with positive pulse signals that are produced at boundaries between adjacent positive half-waves of the output voltage from the diode bridge 12.

Using the input pulse signals as a reference, the CPU 15 outputs rectangular signals from the connection pin DO1 (the third waveform, from the top in FIG. 3), which are synchronized with the output voltage waveform from the diode bridge 12, to thereby control the ON/OFF of the photo-coupler PC1. In this embodiment, when the signal from the connection pin DO1 is high, the photo-coupler PC1 is in the OFF state and when the signal from the connection pin DO1 is low, the photo-coupler PC1 is in the ON state, during which an electric current flows through the red LED set L_{R} as shown in the lowermost waveform in FIG. 3. Thus, by reducing the time period between the input of the pulse signal to the connection pin DI and the turning on of the photo-coupler PC1 (i.e., an OFF-period T_{OFF} of the photo-coupler PC1) to thereby increase the ON-period T_{ON}, the amount of electric current flowing through the red LED set L_{R} is increased, resulting in a higher intensity of the light emitted from the LED set L_{R}. Conversely, the brightness of the light from the red LED set L_{R} can be lowered by increasing the OFF-period T_{OFF}.

In a preferred embodiment, the color illumination device 1 has a plurality of functional modes. The functional modes may include, for example, a manual color selection mode (first functional mode), automatic color changing mode (second functional mode) and flashing mode (third functional mode). In the manual color selection mode, the color illumination device 1 produces a light of a fixed color selected by the user. In the automatic color changing mode, the light color is changed periodically in a predetermined pattern such as Blue→Purple→Red→Orange→Yellow→Green→Greenish Blue→Blue. In the flashing mode, the color illumination device 1 periodically and repeatedly turns on and off, in which the light color may be fixed or change with time. These functional modes of the color illumination device 1 can be selected by operating the switch 4, as described in detail below.

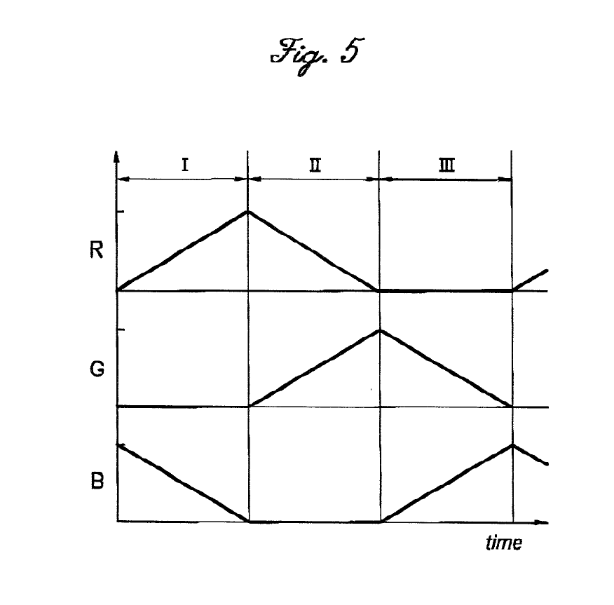

FIG. 4 is a schematic diagram for explaining one embodiment of the functional mode selection in the color illumination device 1. When the power is on, the CPU 15 detects the state of the switch 4 (AUTO/MANUAL), and depending on the result, determines to enter either the manual color selection mode (when the switch 4 is detected to be in MANUAL position) or the automatic color changing mode (when the switch 4 is detected to be in AUTO position).

According to the present invention, when the color illumination device 1 is in the manual color selection mode, the color of the light produced from the device 1 can be changed depending on the position of the second control 5 (in other words, depending on the voltage set by the second control 5). It is possible, for example, that when the second control 5 is fully rotated counterclockwise the device 1 emits a blue light, and as the second control 5 is rotated clockwise (or as the set voltage value is increased), the device 1 continuously change the color of the emitted light such as Blue→Purple→Red→Orange→Yellow→Green→Greenish Blue→Blue. Such light color selection in the manual color selection mode can be achieved by converting the rotational position of the second control 5 (or the voltage corresponding to the position), which is input to the CPU 15, into the information indicating a light color, and depending on this information, adjusting the intensity of the red, green and blue light emitted from the LED sets L_{R}, L_{G}, L_{B} of the three primary colors. Thus, the CPU 15 determines which functional mode is selected, and converts the rotational position of the second control 5 into a predetermined operation parameter corresponding to the selected functional mode.

As described above, in the color illumination device according to the present invention, instead of using three independent controls for red, green and blue light sources, it is possible to change the emitted light color by using only the single control 5, thereby improving the operability of the device 1 and allowing the user to easily select a desired light color. It may be preferable if the selectable colors of light include white, and this can be achieved for example by associating the clockwise fully-rotated position of the second control 5 to white so that the light color changes in the pattern of Blue→Purple→Red→Orange→Yellow→Green→Greenish Blue→White as the second control is rotated clockwise, in which it is preferable if the light color changes gradually between Greenish Blue and White also.

When the color illumination device 1 is in the automatic color changing mode, the operation of the second control 5 can change the cycle (or speed) of the automatic light color change. For example, with the second control being fully rotated counterclockwise, the color change cycle is 5 seconds, and as the second control is rotated clockwise, the cycle is gradually increased to reach 20 seconds when the second control is at the clockwise fully-rotated position.

FIG. 5 shows a preferred embodiment of the intensity change of the red, green and blue lights emitted from the three primary color LED sets L_{R}, L_{G}, L_{B} in the automatic color changing mode. As shown in the drawing, the light color change in a single cycle is divided into three phases I-III. In the phase I, the intensity (or brightness) of blue light is linearly decreased while the intensity of the red light is linearly increased, with the intensity of the green light being held at zero. In the phase II, the red light intensity is linearly decreased, the green light intensity is linearly increased and the blue light intensity is held at zero. Similarly, in the phase III, the green light intensity is linearly decreased, the blue light intensity is linearly increased and the red light intensity is held at zero. Thus, by linearly changing the light intensity of two colors while holding the light intensity of the other color in one phase, the total light intensity at any time can be made constant, thereby achieving a smooth light color change without fluctuation in the brightness. It should be understood that if the abscissa represents the rotational position of the second control 5 (or the voltage set by the second control 5) instead of time, the graph of FIG. 5 can define the correspondence between the position of the second control 5 and the illuminated light color as described above regarding the manual color selection mode.

Referring back to FIG. 4, when the color illumination device is in the automatic color changing mode (i.e., when the switch is in AUTO position), an operation of the switch 4 from AUTO to MANUAL position is detected by the CPU 15, which accordingly causes the device 1 to enter the manual color selection mode. In such an event, the light color at the operation of the switch 4 is maintained until the second control 5 is operated anew. In other words, the automatic color change stops with the light color produced when the switch 4 is operated. When the second control 5 is operated after the manual color selection mode is entered, the CPU 15 detects the operation and controls the electric current flowing through the LED sets L_{R}, L_{G}, L_{B} so as to produce the light of the color determined by the rotational position of the second control 5. In this way, it is possible for the user to change the functional mode from the automatic color changing mode to the manual color selection mode smoothly without feeling any queerness.

In this embodiment, when the color illumination device 1 is in the manual color selection mode, an operation of the switch 4 can bring the device 1 into the automatic color changing mode or the flashing mode. More specifically, when the switch 4 is operated from MANUAL position to AUTO position and kept in that position for two seconds, for example, the device 1 enters the automatic color changing mode while when the switch 4 is brought back to MANUAL position within two seconds after the switch 4 is operated to AUTO position, the device 1 enters the flashing mode. In the flashing mode, the flashing cycle (or speed) may be fixed while an operation of the second control 5 may change the duration time of an ON state (or ON-time) of the device 1 in the flashing operation in a range of 10-90% of the time of a flashing cycle, for example. Alternatively, it may be possible that the ON-time in the single flashing operation is fixed while the operation of the second control 5 changes the flashing cycle (or the time period of the OFF state). In the flashing mode, the light color may be fixed or changed automatically in such a pattern as Blue→Purple→Red→Orange→Yellow→→Green→Greenish Blue→Blue.

When the color illumination device 1 is in the flashing mode (it should be noted that at this time, the switch 4 is in MANUAL position), an operation of switch 4 can bring the device 1 to enter the automatic color changing mode or to the manual color selection mode. Specifically, when the switch 4 is moved from MANUAL position to AUTO position and kept at AUTO position for two seconds, the device 1 enters the automatic color changing mode while the switch 4 is brought back to MANUAL position within two seconds after being moved to AUTO position, the device 1 enters the manual color selection mode.

As described above, in the preferred embodiment of the color illumination device according to the present invention, three different functional modes can be selected by operating the single switch 4. Further, depending on the functional mode selected, the operation of the single control 5 can change different operation parameters such as the light color in the manual color selection mode, the color changing cycle in the automatic color changing mode and the ON-time in the single flashing cycle in the flashing mode. This can provide a color illumination device that can achieve various modes of function with reduced number of control elements (the switch 4 and control 5) and simplified operation, and therefore is particularly suitable for use in the household.

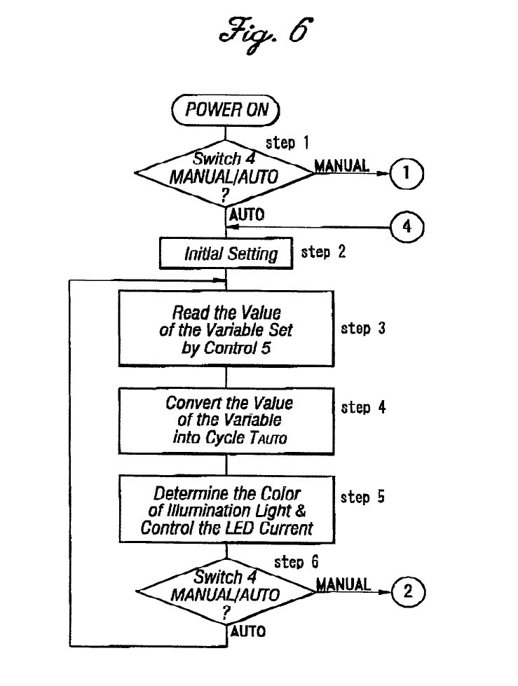

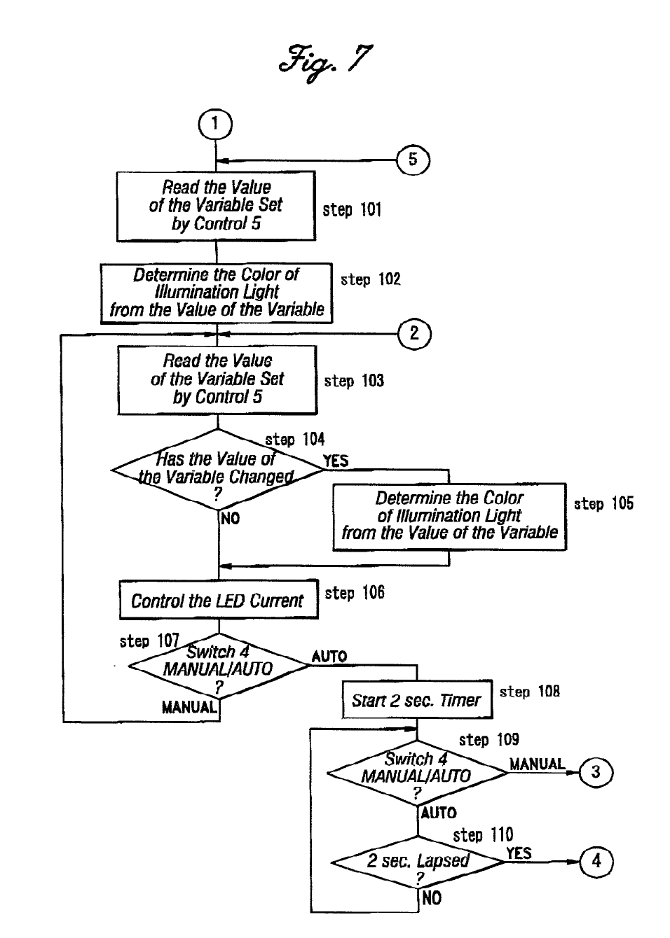

FIGS. 6-8 show a flowchart for explaining the operation of the above-described color illumination device 1. First, when the power is on, the state of the switch 4 is determined in step 1, and when the switch 4 is in AUTO position, the process proceeds to step 2 so that the automatic color changing mode is entered. When the switch 4 is determined to be in MANUAL position, the process proceeds to step 101 so that the manual color selection mode is entered.

Upon entering the automatic color changing mode, initial values of the data required to start the automatic color changing (such as the light color to be produced, etc.) are set in step 2. Then, in step 3, a value of a variable set by the second control 5 (e.g.. voltage value) is read, and the process proceeds to step 4 where the value of the variable obtained in step 3 is converted into the automatic color change cycle T_{AUTO}. Then, in step 5, the light color is determined based on the set data values and the cycle T_{AUTO} so that the electric current supplied to each LED set L_{R}, L_{G}, L_{B} is controlled to produce the determined color of light. In step 6, the state of the switch 4 is checked and when the switch 4 is in AUTO position, the process returns to step 3. Thus, so long as the switch 4 is in AUTO position, the steps 3-6 are repeated to conduct the illumination in the automatic-color changing mode. When the switch 4 is found to be in MANUAL position in step 6, the process proceeds to step 103 to enter the manual color selection mode (see FIG. 7).

When the switch 4 is in MANUAL position in step 1, the process goes to step 101 to read the value of the variable set by the second control 5, and then proceeds to step 102. In step 102, the light color to be produced is determined based on the value of the variable obtained in step 101. Then the process goes to step 103 where the value of the variable set by the second control 5 is read, and in step 104, it is checked whether or not the read value of the variable (i.e., current value of the variable) has changed from the previous value of the variable. If there is no change, then the process proceeds to step 106 to control the electric current supplied to the LED sets L_{R}, L_{G}, L_{B} to produce the selected color of light. If there is a change, the process proceeds to step 105 to determine the light color to be produced based on the current value of the variable obtained in step 103, and goes to step 106. Then in step 107, the state of the switch 4 is checked so that when the switch 4 is in MANUAL position, the process goes back to step 103, while when the switch 4 is in AUTO position, the process proceeds to step 108.

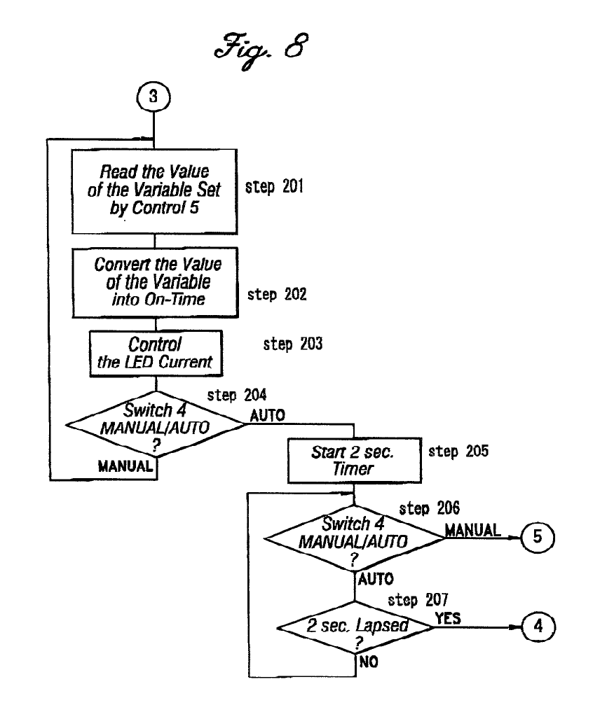

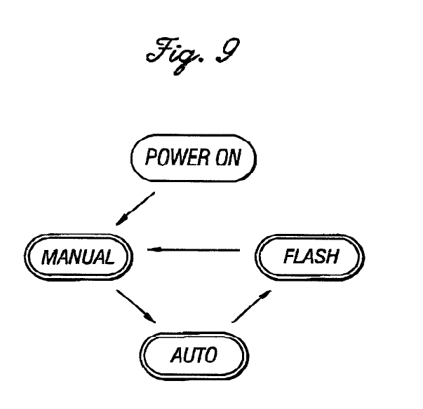

In step 108, a two-second timer is started, and the process goes to step 109 where the state of the switch 4 is checked. When the switch 4 is in MANUAL position, the process goes to step 201 to enter the flashing mode (see FIG. 8). On the other hand, when the switch 4 is in AUTO position, the process goes to step 110 where the timer is checked to determine whether or not two seconds have lapsed. If two seconds have passed, then the process goes to step 2 to enter the automatic color changing mode, and if not, the process returns to step 109.

Upon entering the flashing mode, in step 201, the value of the variable set by the second control 5 is read, followed by step 202 where the read value of the variable is converted into the ON-time in a cycle of the flashing. Then the process goes to step 203 where the electric current to the LED sets L_{R}, L_{G}, L_{B} is controlled according to the predetermined flashing cycle and the ON-time calculated in step 202. In the flashing mode, the illuminated light color may he changed periodically or may be fixed. Further, in step 204, the state of the switch 4 is checked and when it is in MANUAL position, the process goes back to step 201, and when it is in AUTO position, the process goes to step 205.

In step 205, a two-second timer is started, and the process goes to step 206 where the state of the switch 4 is checked. When the switch 4 is in MANUAL position, the process goes to step 101 to enter the manual color selection mode (FIG. 7), and when the switch 4 is in AUTO position, the process goes to step 207 where the timer is checked to determine whether or not two seconds have lapsed. If two seconds have passed, then the process proceeds to step 2 to enter the automatic color changing mode, and if not, the process returns to step 206.

FIG. 9 is a schematic diagram for explaining another embodiment of the functional mode transition in the color illumination device according to the present invention. In this embodiment, when the power is on, the device 1 enters the manual color selection mode irrespective of the position of the switch 4 (in this embodiment, unlike the previous embodiment, the two positions (AUTO/MANUAL) of the switch 4 are not associated with particular functional modes). Then, when the switch 4 is operated (AUTO→MANUAL or MANUAL→AUTO), the CPU 15 of the device 1 detects that an operation is made to the switch 4, and causes the device 1 to enter the automatic color changing mode. If the switch 4 is further operated when the device 1 is in the automatic color changing mode, then, the device 1 enters the flashing mode. Further, when an additional operation is made to the switch 4 when the device 1 is in the flashing mode, then the device enters the manual color selection mode again. Thus, upon each operation of the switch 4, the functional mode of the device 1 sequentially switches to the subsequent mode in a predetermined order cyclically. It should be understood that in this embodiment, the functional modes of the device 1 may not be limited to only three modes (i.e., manual color selection mode, automatic color changing mode and flashing mode) but may comprise an arbitrary number of functional modes. For example, the device 1 may additionally have a functional mode for conducting general, white light illumination. Also, the switch 4 may not necessarily be a lever type switch but can consist of any other suitable switch such as a push button switch or a touch sensor switch.

As described above, in a color illumination device according to the present invention, instead of using three independent controls for red, green and blue light sources as in the conventional embodiment, it is possible to change the emitted illumination light color by using only a single control, thereby significantly improving the operability of the device and allowing the user to easily select a desired light color.

Further, in a color illumination device according to the present invention, three different functional modes can be selected by operating a single switch, and depending on the functional mode selected, an operation of a single control can change different operation parameters such as the light color in the manual color selection mode, the color changing cycle in the automatic color changing mode and the ON-time in a single flashing cycle in the flashing mode. This can provide a color illumination device that can achieve various modes of function with reduced number of control elements and simplified operation.

In a preferred embodiment of the color illumination device according to the present invention, when the functional mode is changed from the automatic color changing mode to the manual color selection mode, the light color effected at the time of the switch operation for the functional mode change is maintained until the control for light color selection is operated anew. In this way, the user is allowed to stop the automatic color change at a desired light color as well as to change the functional mode from the automatic color changing mode to the manual color selection mode smoothly without feeling any queerness.

In another embodiment of the present invention, the functional mode of the color illumination device switches sequentially to the next functional mode in a predetermined order upon each operation of a switch, allowing the user to change a plurality of functional modes of the color illumination device easily with a simple operation. In other words, this can provide a color illumination device that has a number of functions and yet is easy to operate.

Although the present invention has been described in terms of a preferred embodiment thereof, it is obvious to a person skilled in the art that various alterations and modifications are possible without departing from the scope of the present invention which is set forth in the appended claims.

For example, although the above embodiment used LEDs of three primary colors (i.e., red, green and blue), it may be possible to additionally use a white LED set comprising a series-connected plurality of white LEDs by connecting the white LED set in parallel to the three primary color LED sets. Further, the above embodiment was shown as a table lamp type device using a light transmissive and diffusing cover (globe) as a light mixing means, but the present invention may be applied to an indirect lighting device that uses a ceiling or wall as the light mixing means instead of the light transmissive and diffusing cover. Also, in the above embodiment, the first and second controls 3, 5 were shown as variable resistors operable via rotatable knobs, but they may be of a slide lever type or may consist of a pair of push button or touch sensor switches, one of which being for incrementing (digitally) a value of a variable and the other of which being for decrementing the same.

1. A color illumination device for producing light of various colors, comprising:
a plurality of color light sources for emitting lights of at least two different colors;
a control unit for controlling the plurality of color light sources;
a light mixing means for mixing the lights emitted from the plurality of color light sources to produce an illumination light; and
a control operable to change a value of a variable,
wherein the color illumination device has a first functional mode in which the value of the variable determines a color of the illumination light.

2. The color illumination device according to claim 1, wherein the color illumination device has a second functional mode in which the color of the illumination light is changed periodically in a predetermined pattern and the value of the variable determines a cycle of the periodic light color change, and wherein the color illumination device further comprises a switch operable to select one of the functional modes of the color illumination device.

3. The color illumination device according to claim 2, wherein when the functional mode is changed from the second functional mode to the first functional mode by an operation of the switch, the illumination light color effected in the second functional mode at the time of the switch operation for the functional mode change is maintained in the first functional mode until the control is operated anew after the functional mode change.

4. The color illumination device according to claim 3, wherein the control unit comprises:
a memory for storing the color of the illumination light being produced; and
a detector for detecting an operation of the control.

5. The color illumination device according to claim 2, further having a third functional mode which is different from the first and second functional modes,
wherein the switch comprises two different states associated with the first and second functional modes, respectively and wherein in a case that the state of the switch is changed when the color illumination device is in the first functional mode and returned to an original state within a predetermined time period, the color illumination device enters the third functional mode.

6. The color illumination device according to claim 5, wherein in the third functional mode, the color illumination device repeatedly turns on and off at a predetermined cycle, and the value of the variable determines a duration time of the turning on of the color illumination device.

7. The color illumination device according to claim 1, wherein the plurality of color light sources comprise a red LED set having a series-connected plurality of red LEDs, a green LED set having a series-connected plurality of green LEDs, and a blue LED set having a series-connected plurality of blue LEDs, and wherein the control unit comprises a first, second and third switching elements each connected in series to an associated one of the red, green and blue LED sets, and a CPU for controlling the first, second and third switching elements.

8. The color illumination device according to claim 1, the light mixing means comprises a first light diffusing member and a second light diffusing member interposed between the first light diffusing member and the plurality of color light sources, the second light diffusing member having a light transmissive property.

9. The color illumination device according to claim 8, wherein the first light diffusing member comprises a cover having a light transmissive property.

10. A color illumination device for producing light of various colors, comprising:
a plurality of color light sources for emitting lights of at least two different colors;
a control unit for controlling the plurality of color light sources;
a light mixing means for mixing the lights emitted from the plurality of color light sources to produce an illumination light; and
a control operable by a user,
wherein the color illumination device has at least two functional modes and a function of the control is defined for each functional mode,
and wherein the color illumination device further comprises a switch operable to select one of the at least two functional modes.

11. The color illumination device according to claim 10, wherein the control is adapted to change a value of a variable, and the value of the variable is converted into an operation parameter defined for each of the functional modes.

12. The color illumination device according to claim 11, wherein the at least two functional modes comprise a first functional mode in which the value of the variable is converted into a color of the illumination light.

13. The color illumination device according to claim 12, wherein the at least two functional modes comprise a second functional mode in which the color of the illumination light is changed periodically in a predetermined pattern, and the value of the variable is converted into a cycle of the periodic light color change.

14. The color illumination device according to claim 10, wherein the switch is adapted to provide the control unit with a signal for indicating that the switch is operated, and in response to the signal from the switch, the control unit causes a current functional mode to switch to a next functional mode in a predetermined order of the functional modes.
